(19) United States
(12) Patent Application Publication
(10) Pub. No.: US 2017/0017497 A1
(43) Pub. Date: Jan. 19, 2017

(54) USER INTERFACE SYSTEM, USER INTERFACE CONTROL DEVICE, USER INTERFACE CONTROL METHOD, AND USER INTERFACE CONTROL PROGRAM

(71) Applicant: MITSUBISHI ELECTRIC CORPORATION, Tokyo (JP)

(72) Inventors: Atsushi SHIMADA, Tokyo (JP); Masato HIRAI, Tokyo (JP); Hideo IMANAKA, Tokyo (JP); Reiko SAKATA, Tokyo (JP)

(73) Assignee: MITSUBISHI ELECTRIC CORPORATION, Tokyo (JP)

(21) Appl. No.: 15/124,315

(22) PCT Filed: Apr. 22, 2014
(86) PCT No.: PCT/JP2014/002265

§ 371 Date: Sep. 7, 2016

(51) Int. Cl. G06F 9/44; G06F 3/16; G06F 3/0488; G06F 3/0482

(52) U.S. Cl. CPC G06F 9/4443; G06F 3/0482; G06F 3/167; G06F 3/04883

(57) ABSTRACT

An object of the present invention is to allow execution of a target function by an operation means that is easy to operate for a user. In order to achieve the object, a user interface system according to the present invention includes a function-means storage section 5 that stores candidates for a plurality of functions and candidates for a plurality of operation means for issuing an instruction to execute each function, an estimation section 3 that estimates a function intended by a user, and the operation means for issuing the instruction to execute the function, from among the candidates stored in the function-means storage section 5, based on information related to a current situation, and a presentation section 6 that presents the candidate for the function estimated by the estimation section 3, together with the candidate for the operation means for executing the function.

### TECHNICAL FIELD

The present invention relates to a user interface system, a user interface control device, and a user interface control program capable of executing a function by using various means such as a voice operation and a manual operation.

### BACKGROUND ART

Conventionally, a user interface capable of displaying a candidate for a destination estimated based on a travel history, and selecting the displayed candidate for the destination is known (Patent Literature 1).

In addition, a user interface capable of performing a touch operation (manual operation) and a voice operation is known as a means for selecting a displayed candidate (Patent Literature 2).

### CITATION LIST

### Patent Literature

Patent Literature 1: Japanese Patent Application Laid-open No. 2009-180651

Patent Literature 2: WO 2013/015364

### SUMMARY OF THE INVENTION

### Technical Problem

However, in estimation of a candidate for a function intended by a user, an operation means for issuing an instruction to execute the function has not been taken into consideration, and hence the interface has not necessarily been easy to operate for the user.

The present invention has been made in order to solve the above problem, and an object thereof is to allow execution of a target function by the operation means that is easy to operate for the user.

### Solution to Problem

A user interface system according to the invention includes: a function-means storage that stores candidates for a plurality of functions, and candidates for a plurality of operation means for issuing an instruction to execute each of the functions; an estimator that estimates a function intended by a user and the operation means for issuing an instruction to execute the function, from among the candidates stored in the function-means storage, based on information related to a current situation; and a presentator that presents the candidate for the function estimated by the estimator, together with the candidate for the operation means to execute the function.

A user interface control device according to the invention includes: an estimator that estimates a function intended by a user and an operation means for issuing an instruction to execute the function based on information related to a current situation; and a presentation controller that controls a presentator that presents a candidate for the function estimated by the estimator, together with a candidate for the operation means for executing the function.

A user interface control method according to the invention includes the steps of: estimating a function intended by a user, and an operation means for issuing an instruction to execute the function based on information related to a current situation; and controlling a presentator that presents a candidate for the function estimated in the estimating step together with a candidate for the operation means for executing the function.

A user interface control program according to the invention causes a computer to execute: estimation processing that estimates a function intended by a user, and an operation means for issuing an instruction to execute the function based on information related to a current situation; and presentation control processing that controls a presentator that presents a candidate for the function estimated by the estimation processing together with a candidate for the operation means for executing the function.

### Advantageous Effects of Invention

According to the present invention, since the candidate for the function that meets the intention of the user is estimated in consideration of the operation means, it is possible to execute the target function by the operation means that is easy to operate for the user.

### BRIEF DESCRIPTION OF DRAWINGS

FIG. 1 is a view showing a configuration of a user interface system in Embodiment 1;

FIG. 2 is an example of stored data of vehicle information in Embodiment 1;

FIG. 3 is an example of stored data of environment information in Embodiment 1;

FIG. 4 is an example of an estimation result in Embodiment 1;

FIG. 5 is a presentation example of the estimation result in Embodiment 1;

FIG. 6 is a flowchart showing an operation of the user interface system in Embodiment 1;

FIG. 7 is a view showing a configuration of a user interface system in Embodiment 2;

FIG. 8 is a flowchart showing the operation of the user interface system in Embodiment 2;

FIG. 9 is a view showing a configuration of a user interface system in Embodiment 3;

FIG. 10 is a flowchart showing the operation of the user interface system in Embodiment 3;

FIG. 11 is a view showing a configuration of a user interface system in Embodiment 4;

FIG. 12 is a flowchart showing the operation of the user interface system in Embodiment 4;

FIG. 13 is a view showing a configuration of a user interface system in Embodiment 5; and

FIG. 14 is a view showing an example of a hardware configuration of a user interface control device in each of Embodiments 1 to 5.

### DESCRIPTION OF EMBODIMENTS

### Embodiment 1

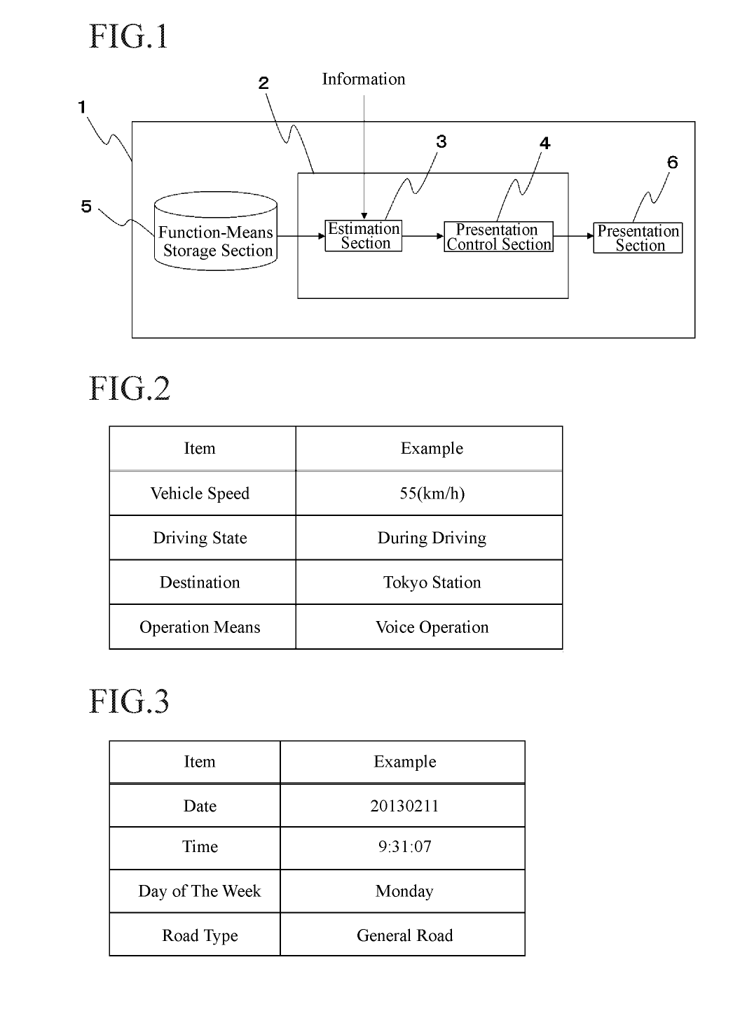

FIG. 1 is a view showing a user interface system in Embodiment 1 of the invention. A user interface system 1 includes a user interface control device 2, a function-means storage section 5, and a presentation section 6. The presentation section 6 is controlled by the user interface control device 2. The user interface control device 2 has an estimation section 3 and a presentation control section 4. Hereinbelow, a description will be made by taking the case where the user interface system 1 is applied to driving of an automobile as an example.

The function-means storage section 5 combines a candidate for each of functions to be executed by equipment such as a car navigation device, an audio, an air conditioner, and a telephone in an automobile, with a candidate for an operation means of a user that issues an instruction to execute each of these function candidates, and stores the results. Examples of the function include: a function of setting a destination by the car navigation device; a function of playing back music by the audio; a function of setting the temperature to 28 degrees by the air conditioner; and a function of calling home by the telephone. Examples of the operation means include a manual operation, a voice operation, and a gesture operation. The manual operation includes an operation in which a touch panel is touched or a button is pushed, and also includes a folder operation in which the function is determined such that levels from a superordinate concept to a subordinate concept are traced, in addition to the case where the function is executed by one operation. The gesture operation is an operation means that performs input with a gesture or a hand gesture.

The estimation section 3 acquires information related to a current situation in real time, and estimates what a user desires to do at the moment, and by which kind of operation means the user desires what the user desires to do. That is, the estimation section 3 estimates the candidate for the function that the user will perform at the moment, that is, the candidate for the function intended by the user, and the candidate for the operation means for issuing an instruction to execute the function, from among the combinations of the functions and operation means that are stored in the function-means storage section 5. The function-means storage section 5 may be stored in a storage section of a server or may also be stored in a storage section in the user interface control device 2.

Examples of the information related to the current situation include external environment information and history information. The estimation section 3 may use both of the external environment information and history information or may also use either one of them. Examples of the external environment information include vehicle information and environment information. Examples of the vehicle information include the current speed of an own vehicle, a driving state (during driving or stop, etc.), a brake condition, and a destination, and are acquired with a CAN (Controller Area Network) or the like. FIG. 2 shows an example of stored data of the vehicle information. Examples of the environment information include a date, a day of the week, current time, temperature, a current position, a road type (general road or express highway, etc.), and traffic jam information. The temperature is acquired with a temperature sensor or the like, and the current position is acquired by a GPS signal transmitted from a GPS (Global Positioning System) satellite. FIG. 3 shows an example of stored data of the environment information.

The history information includes, for example, in the past, setting information of a facility set as a destination by a user, and equipment such as the car navigation device operated by the user, and a content selected by the user from among presented candidates, and is stored together with date and time of occurrence, position information etc. of each of the setting information, content, etc. Consequently, the estimation section 3 uses for the estimation, the information related to the current time and current position in the history information. Thus, even in the past information, the information that influences the current situation is included in the information related to the current situation. The history information may be stored in a storage section in the user interface control device 2 or may also be stored in a storage section of the server.

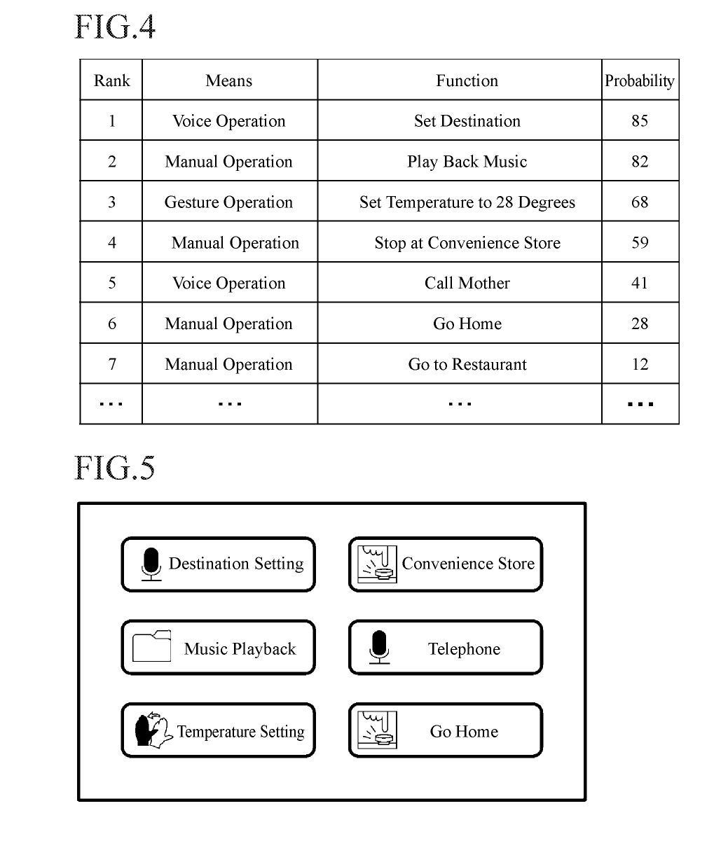

The estimation section 3 assigns a probability that matches the intention of the user to each of the combinations of the functions and the operation means stored in the function-means storage section 5, and outputs the results to the presentation control section 4. Alternatively, the estimation section may output a combination in which the probability that matches the intention of the user is a predetermined value or more, or may also output a predetermined number of combinations. FIG. 4 shows an example of an estimation result. For example, the intention of the user that desires to execute a function of “set destination” with “voice operation” is estimated to be 85%, the intention of the user that desires to execute a function of “play back music” with “manual operation” is estimated to be 82%, and the intention of the user that desires to execute a function of “set temperature to 28 degrees” with “gesture operation” is estimated to be 68%.

The presentation control section 4 outputs the candidates by the number that can be presented by the presentation section 6 to the presentation section 6 in descending order of the probabilities that match the intention of the user. The presentation section 6 presents the candidates received from the presentation control section 4 to the user as the estimation results, and allows the selection of the function desired by the user with the operation means desired by the user. Hereinbelow, a description will be made on the assumption that the presentation section 6 is a touch panel display. FIG. 5 shows an example in the case where top six out of the estimation results in FIG. 4 are displayed.

The candidate for each function is displayed such that the user can recognize the operation means for issuing the instruction to execute each function. In the example in FIG. 5, the candidate for each function is displayed with an icon indicative of the operation means. Thus, with the display for recognizing the operation means, the user can grasp with what kind of operation means the function should be executed, and hence the user can start the operation without anxiety. For example, with regard to the function of performing the destination setting, letters of “destination setting” and the icon of a voice operation are displayed. With regard to the function of performing the retrieval of a convenience store, letters of “convenience store” and the icon indicative of a manual operation input are displayed. With regard to the function of performing playback of music, letters of “music playback” and the icon indicative of a holder operation input are displayed. In addition, with regard to the function of performing temperature setting, letters of “temperature setting” and the icon indicative of a gesture operation are displayed. Note that, with regard to the display for recognizing the operation means, colors, letters and the like may be something other than the icon. In addition, six candidates are displayed in the example of FIG. 5, but the number of displayed candidates, a display order thereof, and a layout thereof may be any number, any order, and any layout, respectively.

The user selects the candidate for the function that the user desires to execute from among the displayed candidates. With regard to a selection method, the candidate displayed on the touch panel display may be appropriately touched and selected. In the case where the function to be performed by the voice operation is selected, a voice input is performed after the displayed candidate is touched once. For example, after the display of “destination setting” is made by the touch operation, a guidance of “where do you go?” is outputted, and a destination is inputted by voice when the user answers the guidance. The selected function is accumulated as the history information together with time information, the position information and so on, and is used for future estimation of the candidate for the function.

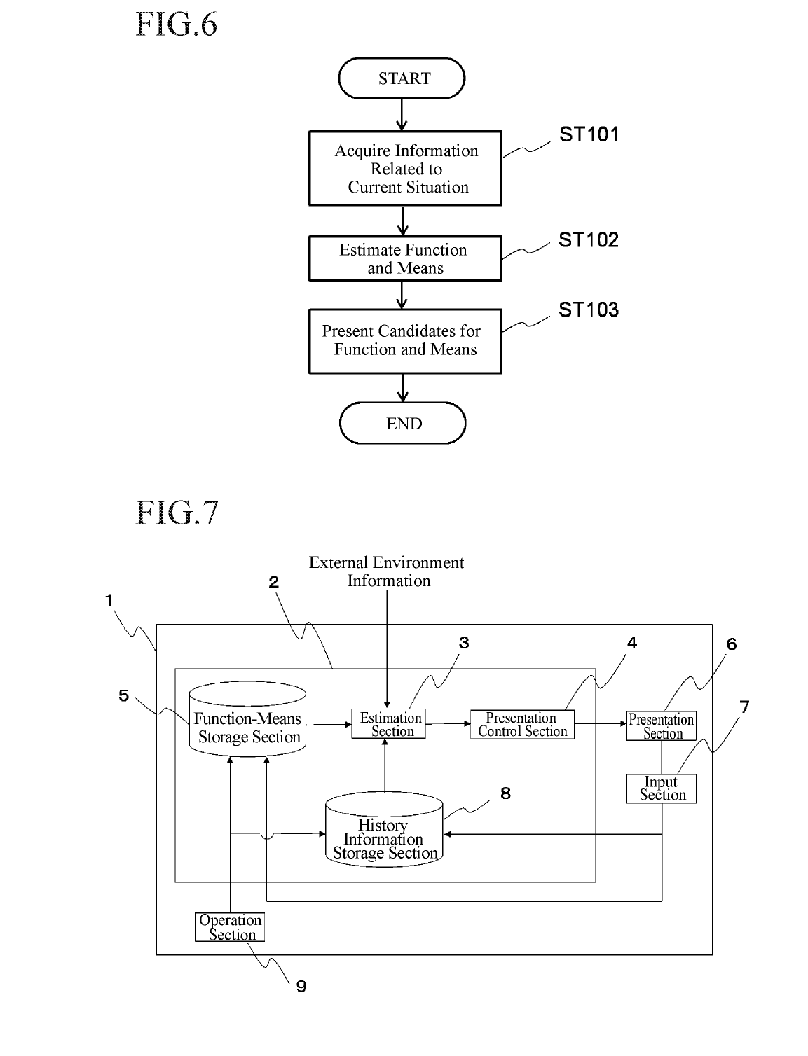

FIG. 6 is a flowchart for explaining the operation of the user interface system in Embodiment 1. In the flowchart, operations in ST101 and ST102 are operations of the user interface control device (i.e., processing procedures of a user interface control program). The operations of the user interface control device and the user interface system will be described with reference to FIGS. 1 to 6.

The estimation section 3 acquires the information related to the current situation (external environment information, operation history, and the like) (ST101), and estimates the candidates for the function that the user will desire to execute and the operation means that the user will desire to use (ST102). In the case where the user interface system is used as, for example, a vehicle-mounted device, this estimation operation may be started at the time an engine is started, and may be periodically performed, for example, every second or may also be performed at a timing when the external environment is changed.

The presentation control section 4 extracts the candidates for the function and the operation means to be presented to the presentation section 6 and generates data to be presented, and the presentation section 6 presents the candidates for the function and the operation means based on the data generated by the presentation control section 4 (ST103). The operations from ST101 to ST103 are repeated until the driving is ended.

In the above description, the following is configured: the presentation section 6 is the touch panel display, the desired function is selected by the touching of the displayed candidate, and the input by the desired operation method is started. But the configuration of the presentation section 6 is not limited thereto. For example, the candidate displayed on the display may be selected by a cursor operation with a joystick or the like. In addition, a hard button corresponding to the candidate displayed on the display may be provided in a handle or the like, and the candidate may be selected by a push of the hard button. Further, the estimated candidate may be outputted by voice from a speaker, and the candidate may be selected by the user with a button operation, joystick operation, or voice operation. In this case, the speaker serves as the presentation section 6.

In addition, in the above description, it is configured that the candidates for the function and the candidates for the operation means are combined and stored in the function-means storage section 5, but they may also be stored separately without being combined with each other. In this case, in the estimation section 3, the probability that each combination in the above candidates matches the intention of the user may be calculated. Further, the following may be configured: the candidate for the function having a high probability that matches the intention of the user and the candidate for the operation means having a high probability that matches the intention of the user are extracted separately; the extracted ones are combined in descending order of the probabilities; and a predetermined number of candidates are outputted to the presentation control section 4.

As described above, according to the user interface system and the user interface control device in Embodiment 1, since the candidate for the function and the candidate for the operation means intended by the user are presented in accordance with the situation, it is possible to execute a target function by the means that is easy to operate for the user.

### Embodiment 2

In the present Embodiment 2, a description will be given of the user interface system and the user interface control device in which the stored content of the function-means storage section 5 is updated based on the selection by the user. In addition, in the user interface system and the user interface control device in Embodiment 2, it is assumed that both of the external environment information and history information are used as the information related to the current situation. FIG. 7 is a view showing the user interface system in Embodiment 2. In the present embodiment, a point different from those in Embodiment 1 will be mainly described.

An input section 7 is provided for the user to select one candidate from among the candidates presented in the presentation section 6. For example, when the presentation section 6 is the touch panel, the user selects the candidate by touching the touch panel, and hence the touch panel itself serves as the input section 7. In addition, the presentation section 6 and the input section 7 may be configured separately. For example, the candidate displayed on the display may be selected by the cursor operation with the joystick or the like. In this case, the display serves as the presentation section 6, and the joystick or the like serves as the input section 7. In addition, the hard button corresponding to the candidate displayed on the display may be provided in the handle or the like, and the candidate may be selected by the push of the hard button. In this case, the display serves as the presentation section 6, and the hard button serves as the input section 7. Further, the displayed candidate may be selected by the gesture operation. In this case, a camera or the like that detects the gesture operation serves as the input section 7. In addition, the estimated candidate may be outputted by voice from the speaker, and the candidate may be selected by the user with the button operation, joystick operation, or voice operation. In this case, the speaker serves as the presentation section 6, and the hard button, the joystick, or a microphone serves as the input section 7. Further, the input section 7 has not only a role that selects the presented candidate but also a role that traces the levels by the folder operation to select the target function from among the presented candidates.

An operation section 9 is a section that selects the target function by the will of the user separately from the estimation by the estimation section 3, and is provided with, for example, an operation button of the air conditioner or an operation button of the audio.

When the user selects one function through the input section 7 from among the candidates presented by the presentation section 6 (the candidates indicative of the function and the operation means for issuing the instruction to execute the function), the selected function and operation means are outputted to a history information storage section 8. In the history information storage section 8, the information on the selected function and the selected operation means is stored together with the information on the time when the user made the selection, the position information, and so on. When the history information is updated, the probability that the function and the operation means are presented as the estimation result at the next estimation operation is increased, so that accuracy in estimation is enhanced.

In addition, after the selection of the function by the user, in the case where the function of a lower level is finally selected by, for example, the folder operation or the voice operation, when the finally selected function is a function selected for the first time, that function is newly stored in the function-means storage 5. For example, in the case where the presented function is “destination setting”, and the finally set destination is “ . . . golf course” to be set for the first time, “ . . . golf course” is newly stored in the function-means storage section 5. On this occasion, the new function is stored in combination with all of the operation means. In the subsequent estimation, “ . . . golf course” is presented as the estimation result by the presentation section 6 together with the operation means in accordance with the external environment information and history information.

In the case where the user selects the target function from the operation section 9 and the function is not stored in the function-means storage section 5, the function is newly stored in the function-means storage section 5. On this occasion, the new function is stored in combination with all of the operation means. In addition, the function selected in the operation section 9 is outputted to the history information storage section 8. The selected function is stored in the history information storage section 8 together with the information on the time when the user made the selection, the position information, and so on.

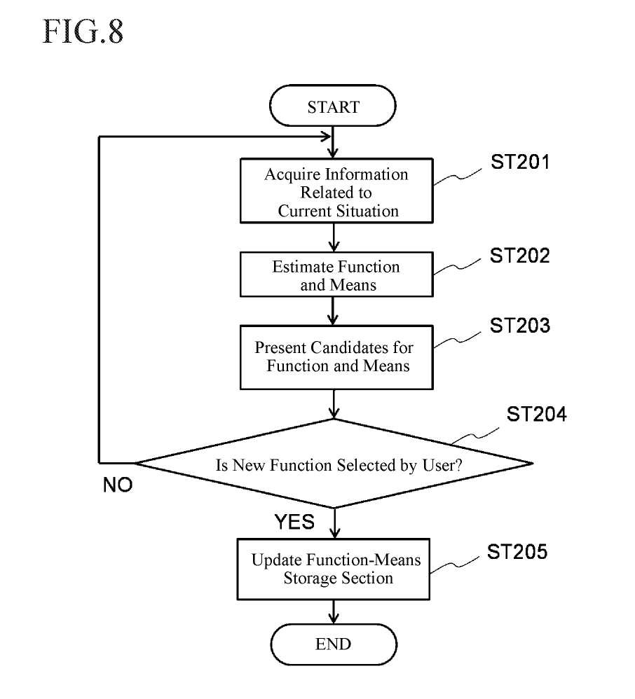

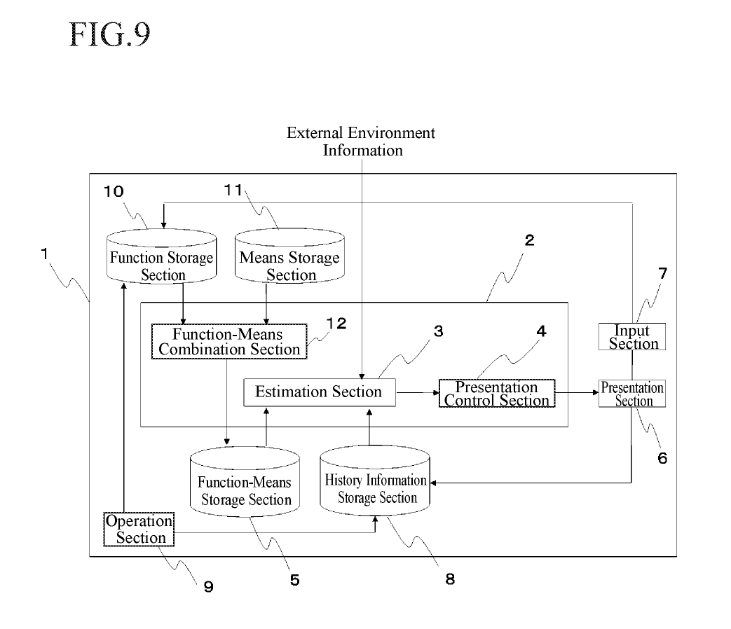

FIG. 8 is a flowchart of the user interface system in Embodiment 2. In the flowchart, at least operations in ST201 and ST202 are operations of the user interface control device (i.e., processing procedures of the user interface control program). In FIG. 8, ST201 to ST203 are the same as ST101 to ST103 in FIG. 6 explaining Embodiment 1, and hence descriptions thereof will be omitted.

When the user performs the selection of the function through the input section 7 or operation section 9, the input section 7, the operation section 9, or a determination section that is not shown determines whether or not the selected function is the new function (ST204) and, in the case where the new function is selected, the function-means storage section 5 is updated (ST205). On the other hand, in the case where the new function is not selected, the flow returns to ST201, and the estimation of the function and the operation means that meet the intention of the user is repeated. Note that the function-means storage section 5 may be updated in a manner that the function that has never been selected from the input section 7 or the operation section 9 or the function having a low frequency of selection from the function-means storage section 5 is deleted. When the unneeded function is deleted, it is possible to reduce a memory capacity, so that the speed of the estimation processing is increased.

In the above description, the following example has been described: the function-means storage section 5 is updated in the case where the selected function is the new function. But the function-means storage section 5 may be updated in accordance with the selected operation means. For example, in the case where the user does not perform the voice operation, the candidate that includes “voice operation” may be deleted from the function-means storage section 5, or after the candidate is deleted temporarily, when the user performs the voice operation, the function executed at the time and the voice operation may be combined to be newly stored in the function-means storage section 5. Thus, when the update related to the operation means is configured to be performed, it is possible to store the combination of the function and the operation means desired by the user, so that accuracy in the estimation of the candidate for the function and the candidate for the operation means is further improved.

In the above description, the following example has been described: the new function is stored in the function-means storage section 5 in combination with all of the operation means. But the method for updating the function-means storage section 5 is not limited to the above example. In the case where the function-means storage section 5 is a storage section that stores the function and the operation means separately without combining them, the new function may be additionally stored in the function-means storage section 5 as it is. In this case, in the estimation section 3, the function and the operation means may be combined, and the probability that each combination thereof matches the intention of the user may be calculated. In addition, the following may be configured: the candidate for the function having a high probability that matches the intention of the user, and the candidate for the operation means having a high probability that matches the intention of the user are extracted separately; the candidates are combined in descending order of the probabilities; and a predetermined number of candidates are outputted to the presentation control section 4.

In addition, in the above description, the following example has been described: the function-means storage section 5 and the history information storage section 8 are provided in the user interface control device 2. But a configuration in which they are not included in the user interface control device 2 (e.g., they are provided in the server) may also be given.

As described above, according to the user interface system and the user interface control device in Embodiment 2, since the function-means storage section is updated in accordance with the selection by the user, the accuracy in the estimation of the candidate for the function and the candidate for the operation means intended by the user is further improved.

### Embodiment 3

Embodiment 3 is characterized in that the list of the function candidate and the list of the operation means candidate are separately stored and each list is updated based on the operation of the user, and that a function-means combination section that generates a new combination of the function and the operation means based on the updated lists is provided. In the present embodiment, points different from those in Embodiment 2 will be mainly described.

FIG. 9 is a view showing a user interface system in Embodiment 3. A function storage section 10 stores the candidates for the functions to be executed by the equipment such as the car navigation device, audio, air conditioner, or telephone in the automobile. A means storage section 11 stores the operation means of the user that issues the instruction to execute the function. A function-means combination section 12 generates all of combinations of the candidates for the functions stored in the function storage section 10 and the operation means stored in the means storage section 11. Then, the function-means combination section generates new combinations every time the function storage section 10 is updated. When the new combinations are generated by the function-means combination section 12, the function-means storage section 5 is updated.

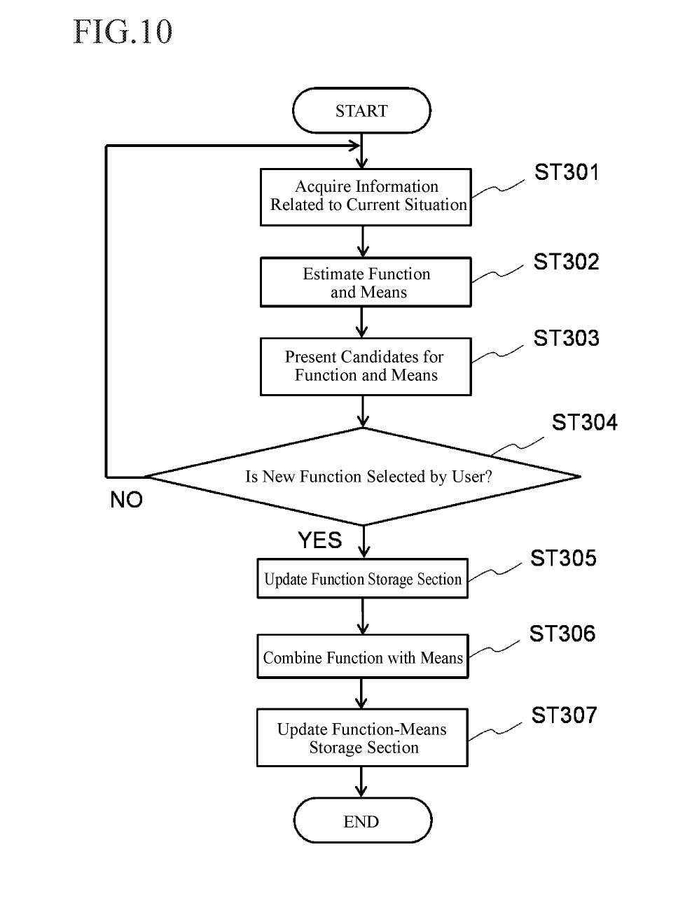

FIG. 10 is a flowchart of the user interface system in Embodiment 3. In the flowchart, at least operations in ST301, ST302, and ST306 are operations of the user interface control device (i.e., processing procedures of the user interface control program). In FIG. 10, ST301 to ST303 are the same as ST101 to ST103 in FIG. 6 explaining Embodiment 1, and hence descriptions thereof will be omitted.

When the user performs the selection of the function through the input section 7 or operation section 9, the input section 7, operation section 9, or determination section that is not shown determines whether or not the selected function is the new function (ST304) and, in the case where the new function is selected, the function storage section 5 is updated (ST305). When the function storage section 5 is updated, the function-means combination section 12 generates all combinations with the operation means stored in the means storage section 11 (ST306). The function-means storage section 5 is updated in a manner that the generated combinations of the new function and the operation means in the function-means storage section 5 are stored (ST307). On the other hand, in the case where the new function is not selected, the flow returns to ST301, and the estimation of the function and the operation means that meet the intention of the user is repeated.

In the above description, the example in which the function storage section 10 is updated has been described, but a configuration in which the means storage section 11 is updated based on the operation of the user may also be given. For example, in the case where the user does not perform the voice operation, the candidate of “voice operation” may be deleted from the means storage section 11, or after the candidate is deleted temporarily, the candidate of “voice operation” may be added thereto when the user performs the voice operation. Thus, when it is configured that the list of the operation means stored in the means storage section 11 is also updated, it is possible to generate the combination of the function and the operation means corresponding to a user's taste, so that the accuracy in the estimation of the candidate for the function and the candidate for the operation means is further improved.

In addition, in the above description, it is configured that the function-means combination section 12 generates all of the combinations of the function and the operation means, but the combination may be changed in accordance with the type of the function. For example, in the case where the selected function is the specific function of the lower level that leads to the final execution (e.g., a function “go home”), the voice operation or the folder operation is not necessary in order to execute the function, and hence the candidate for the function may be appropriately combined with only the manual operation and the gesture operation. In the case where such processing is performed, a storage section that stores a list in which the function candidates are classified according to the levels from the superordinate concept to the subordinate concept is provided, and the function-means combination section 12 refers to the list. Thus, when it is configured that the operation means to be combined are changed in accordance with the type of the function, it is possible to reduce the memory capacity, so that the speed of the estimation processing is increased.

In addition, in FIG. 9, the configuration is given in which the function storage section 10, means storage section 11, function-means storage section 5, and history information storage section 8 are not included in the user interface control device 2 (e.g., they are provided in the server, but a configuration in which they are provided in the user interface control device 2 may also be given.

As described above, according to the user interface system and the user interface control device in Embodiment 3, since the function-means storage section is updated in accordance with the selection of the function by the user, similarly to Embodiment 2, the accuracy in the estimation of the candidate for the function intended by the user and the candidate for the operation means is further improved.

### Embodiment 4

A user interface system and a user interface control device in Embodiment 4 are characterized in that the current situation is determined, the combination that cannot occur in the current situation is excluded from among the combinations of the functions and operation means that are stored in the function-means storage section 5, and that a probability that presents the combination of the function and the means that is more suitable for the current situation is increased. In the present embodiment, points different from those in Embodiment 3 will be mainly described.

FIG. 11 is a view showing the user interface system in Embodiment 4. A situation determination section 13 acquires the external environment information, namely the vehicle information and environment information, and determines the current situation. For example, the situation determination section 13 determines whether the vehicle is during driving or stop from the vehicle information, and determines whether the current position is on the express highway or general road from the environment information. Subsequently, the situation determination section 13 checks the determination results with the combination of the function and the operation means acquired from the function-means storage section 5, and outputs instruction information to the estimation section 3 such that the probability that presents as the estimation result, the combination of the function and the means that is more suitable for the current situation is increased.

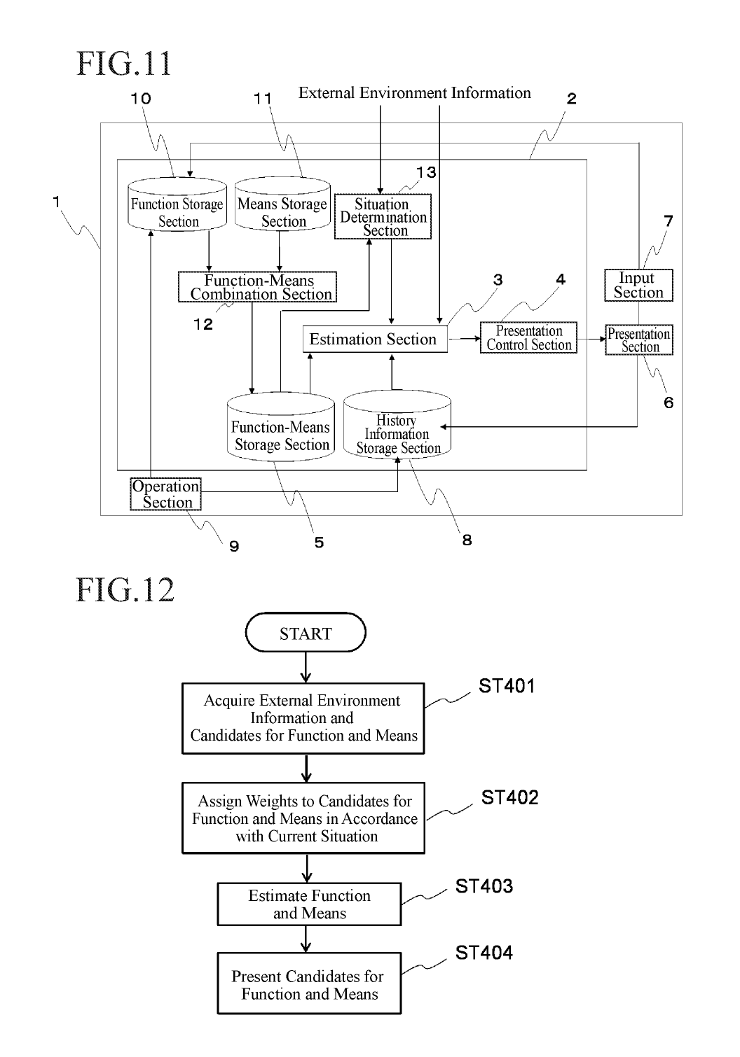

FIG. 12 is a flowchart of the user interface system in Embodiment 4. In the flowchart, operations in ST401 to ST403 are operations of the user interface control device (i.e., processing procedures of the user interface control program). The situation determination section 13 acquires the external environment information, that is, the vehicle information and environment information (ST401). In addition, the situation determination section 13 acquires the candidate for the combination of the function and the operation means from the function-means storage section 5 (ST401).

The situation determination section 13 assigns a weight to the combination of the candidate for the function and the candidate for the operation means in accordance with the current situation determined from the external environment information (ST402). Specifically, the weight is assigned to the candidate such that the candidates for the function and the operation means corresponding to the current situation are outputted as the estimation result when the estimation section 3 assigns the probability that matches the intention of the user to each candidate and outputs the estimation result to the presentation section 6. While the estimation section 3 estimates the candidate having a high probability to be intended by the user by using the external environment information and the information on the operation history of the user, the situation determination section 13 determines what the function or the operation means corresponding to the current situation determined from the external environment information is, irrespective of the operation history of the user. For example, in the case where it is determined that the vehicle is during driving from the vehicle information, the folder operation during driving is prohibited, and hence the candidate that includes the holder operation is excluded. In addition, in the case where it is determined that the vehicle is during stop from the vehicle information, there is time to spare and the manual operation is also higher in reliability than the voice operation, and hence the weight is assigned to the candidate that includes the manual operation. Further, in the case where it is determined that the road on which the vehicle is currently running is the general road (urban area) from the environment information and it is determined that the vehicle is during driving from the vehicle information, it is difficult to move the line of sight from the front in the urban area crowded with people, and hence the weight is assigned to the candidate that includes the voice operation. Furthermore, immediately after a departure from home, the function of “go home” may be excluded.

By assigning the probability that matches the intention of the user to the weight assigned candidate, the estimation section 3 estimates what function the user desires to execute and by what kind of operation means the user desires to implement the function (ST403). The presentation control section 4 outputs the candidates by the number that can be presented by the presentation section 6, to the presentation section 6 as the estimation result in descending order of the probabilities that match the intention of the user. The presentation section 6 presents the candidates acquired from the presentation control section 4 (ST404). Operations after ST404 are the same as the operations after ST303 in FIG. 10, and hence descriptions thereof will be omitted.

The configuration in which the situation determination section 13 is added to the user interface in Embodiment 3 has been described in the above, but the situation determination section 13 may be added to the user interface in Embodiment 1 or Embodiment 2.

In the above description, the example in which the function storage section 10, means storage section 11, function-means storage section 5, and history information storage section 8 are provided in the user interface control device 2 has been described, but a configuration in which they are not included in the user interface control device 2 (e.g., they are provided in the server) may also be given.

According to the user interface system and the user interface control device in Embodiment 4, it is possible to prevent an impediment to driving due to the presentation of the operation means that cannot be actually operated.

### Embodiment 5

In each of Embodiments 1 to 4, it is configured that the combination of the function and the operation means intended by the user is estimated by the use of the function-means storage section is adopted, but a user interface system and a user interface control device in Embodiment 5 are characterized in that the estimation of the function and the estimation of the operation means are performed separately. In the present embodiment, a point different from those in Embodiment 3 will be mainly described.

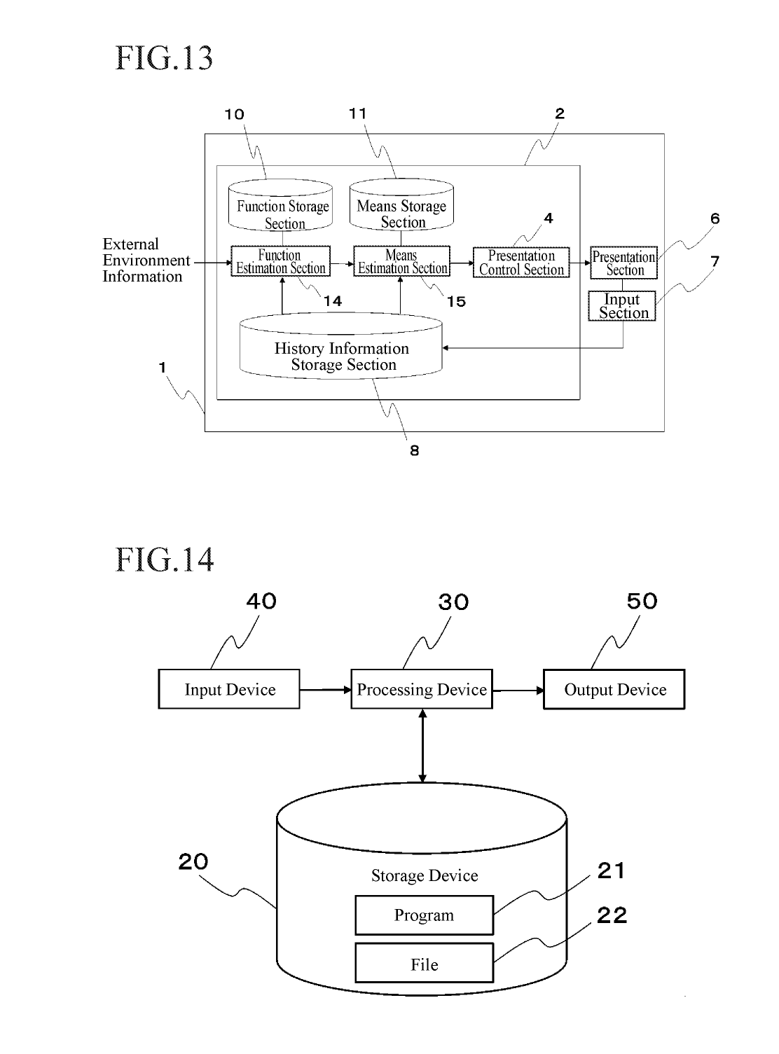

FIG. 13 is a view showing the user interface system in Embodiment 5. A function estimation section 14 acquires the external environment information and history information in real time, and estimates what the user desires to do, that is, the function that the user desires to execute (the function intended by the user), from among the functions stored in the function storage section 10 based on the current external environment information and history information. With regard to the function estimated by the function estimation section 14, a means estimation section 15 estimates by what kind of operation means the user desires to execute the function based on the history information and external environmental situation by using the means storage section 11. Note that the function estimation section 14 and means estimation section 15 constitute “an estimator” in the invention. In addition, in the present embodiment, the function storage section 10 and means storage section 11 constitute “a function-means storage” in the invention.

The estimation is performed, for example, in a manner that assigns the probability that matches the intention of the user. For example, the operation means used at the time the function was selected in the past has a high probability to be used by the user again, and hence the probability that matches the intention of the user is high. In addition, a character of the user, that is, which operation means the user tends to use, is determined from the past history, and the probability of the operation means frequently used by the user is increased. Further, when the tendency of a frequently used operation means is stored for each user, the estimation may be performed by using the stored information that matches the current user. In this case, the information indicative of the character of the user that is stored for each user corresponds to the information related to the current situation. Further, the proper operation means may be estimated in accordance with the current driving state. For example, when the vehicle is during driving, the probability of the voice operation is made higher than that of the manual operation.

In the above description, the estimation of the operation means is performed after the estimation of the function, but the estimation of the operation means may be performed first, and the estimation of the function may be then performed.

In the above description, the example in which the function storage section 10, the means storage section 11, and the history information storage section 8 are provided in the user interface control device 2 has been described, but a configuration in which they are not included in the user interface control device 2 (e.g., they are provided in the server) may also be given.

According to the user interface system and the user interface control device in Embodiment 5, since it is possible to estimate the proper operation means in accordance with the current situation, the accuracy in the estimation of the candidate for the function and the candidate for the operation means that meet the intention of the user is further improved.

FIG. 14 is a view showing an example of a hardware configuration of the user interface control device 2 in each of Embodiments 1 to 5. The user interface control device 2 is a computer, and includes hardware such as a storage device 20, a processing device 30, an input device 40, and an output device 50. The hardware is used by the individual sections of the user interface control device 2 (the estimation section 3, presentation control section 4, function-means combination section 12, situation determination section 13, and the like).

The storage device 20 is, for example, a ROM (Read Only Memory), a RAM (Random Access Memory), or an HDD (Hard Disk Drive). Each of the storage section of the server and the storage section of the user interface control device 2 can be implemented by the storage device 20. In the storage device 20, a program 21 and a file 22 are stored. The program 21 includes programs that execute processing of the individual sections. The file 22 includes data, information, and signals of which input, output, and operations are performed by the individual sections. In the case where the function-means storage section 5, history information storage section 8, function storage section 10, and means storage section 11 are included in the user interface control device 2, these sections are also included in the file 22.

The processing device 30 is, for example, a CPU (Central Processing Unit). The processing device 30 reads the program 21 from the storage device 20, and executes the program 21. The operations of the individual sections of the user interface control device 2 can be implemented by the processing device 30.

The input device 40 is used for input (reception) of data, information, and signals by the individual sections of the user interface control device 2. In addition, the output device 50 is used for output (transmission) of data, information, and signals by the individual sections of the user interface control device 2.

### REFERENCE SIGNS LIST

1: user interface system

2: user interface control device

3: estimation section

4: presentation control section

5: function-means storage section

6: presentation section

7: input section

8: history information storage section

9: operation section

10: function storage section

11: means storage section

12: function-means combination section

13: situation determination section

14: function estimation section

15: means estimation section

20: storage device

21: program

22: file

30: processing device

40: input device

50: output device

1. A user interface system comprising:
a function-means storage that stores candidates for a plurality of functions, and candidates for a plurality of operation means for issuing an instruction to execute each of the functions;
an estimator that estimates a function intended by a user and the operation means for issuing an instruction to execute the function, from among the candidates stored in the function-means storage, based on information related to a current situation; and
a presentator that presents the candidate for the function estimated by the estimator, together with the candidate for the operation means to execute the function.

2. The user interface system according to claim 1, wherein
the function-means storage is updated based on a selection of the function by the user.

3. The user interface system according to claim 1, wherein
the estimator estimates the function intended by the user, and the operation means for issuing the instruction to execute the function based on external environment information and history information.

4. The user interface system according to claim 1, wherein the estimator estimates the function intended by the user and the operation means by using a function or operation means corresponding to the current situation determined from external environment information.

5. A user interface control device comprising:
an estimator that estimates a function intended by a user and an operation means for issuing an instruction to execute the function based on information related to a current situation; and
a presentation controller that controls a presentator that presents a candidate for the function estimated by the estimator, together with a candidate for the operation means for executing the function.

6. The user interface control device according to claim 5, further comprising:
a function-means combiner that generates, when a new function is selected by the user or when a new operation means is used by the user, a new combination of the function and the operation means by using the new function or the new operation means, wherein
the estimator performs the estimation by using the new combination.

7. The user interface control device according to claim 5, wherein
the estimator estimates the function intended by the user, and the operation means for issuing the instruction to execute the function based on external environment information and history information.

8. The user interface control device according to claim 5, further comprising:
a situation determinator that determines what a function or operation means corresponding to the current situation is, based on external environment information, wherein
the estimator estimates the function intended by the user and the operation means based on a result of the determination.

9. A user interface control method comprising the steps of:
estimating a function intended by a user, and an operation means for issuing an instruction to execute the function based on information related to a current situation; and
controlling a presentator that presents a candidate for the function estimated in the estimating step together with a candidate for the operation means for executing the function.

10. A user interface control program causing a computer to execute:
estimation processing that estimates a function intended by a user, and an operation means for issuing an instruction to execute the function based on information related to a current situation; and
presentation control processing that controls a presentator that presents a candidate for the function estimated by the estimation processing together with a candidate for the operation means for executing the function.
